(19) United States
(12) Patent Application Publication
(10) Pub. No.: US 2008/0211990 A1
(43) Pub. Date: Sep. 4, 2008

(54) SURFACE LIGHT SOURCE DEVICE AND DISPLAY APPARATUS

(75) Inventor: Seiji SAKAI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/966,345

(22) Filed: Dec. 28, 2007

(30) Foreign Application Priority Data
Jan. 23, 2007 (JP) 2007-012322

(51) Int. Cl. G02F 1/13357; F21V 5/00

(52) U.S. Cl. 349/64; 315/210; 362/246

(57) ABSTRACT

A liquid crystal display apparatus is provided which has two or more options in selection of the range of viewing angles. A surface light source device according to the invention has a main surface from which light is emitted, and includes a plurality of light guide plates corresponding to a plurality of regions obtained by dividing the main surface in parallel; an optical film provided on the exit surface side of the light guide plates; and a light driver that controls the turning on and off of the plurality of light guide plates. The optical film includes a light-guide slit film which transmits light that is emitted from the light guide plates and that is within a certain range of angles.

### BACKGROUND OF THE INVENTION

1. Field of the Invention

The present invention relates to surface light source devices and display apparatuses, and especially to those which are applicable to and as liquid crystal display apparatuses.

2. Description of the Background Art

Liquid crystal display apparatuses can display images of, for example, pictures or data by illuminating the back surface of a liquid crystal panel with light emitted from a surface light source device, and they have been rapidly improving in recent years by making the most of their characteristics such as thin profile and light weight. On the other hand, greater importance is being placed on protection of images or data to respect personal privacy, so that display apparatuses that can prevent images or data from being seen by others except a viewer of the images or data are desired.

To achieve such display apparatuses, surface light source devices disclosed in Japanese Patent Publication No. 3271695 include two light guide plates vertically placed, and by turning on their respective light sources, allows switching between an ordinary range of viewing angles and a narrower range of viewing angles (narrow viewing angles).

However, the display apparatuses proposed in Japanese Patent Publication No. 3271695 have a problem that it has limited options, namely two options, in selection of viewing angles. There is also another problem that, since the upper light guide plate transmits light whose direction is controlled by a light-shield slit film, a matte finish pattern of the upper guide plate causes light scattering, resulting in the tendency to widen the actual range of viewing angles greater than the desired range.

### SUMMARY OF THE INVENTION

It is an object of the invention to provide liquid crystal display apparatuses that have two or more options in selection of the range of viewing angles.

A surface light source device according to the invention has a main surface from which light is emitted, and includes a plurality of light emitting blocks corresponding to a plurality of regions obtained by dividing the main surface in parallel; an optical film provided on an exit surface side of the plurality of light emitting blocks; and a light driver that controls the turning on and off of the plurality of light emitting blocks. The optical film includes a light-shield slit film that transmits light that is emitted from the plurality of light emitting blocks and that is within a certain range of angles.

This allows selection of the range of viewing angles from two or more options and thereby enables the protection of privacy data.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded view of a liquid crystal display apparatus of a first preferred embodiment;

FIG. 2 is an exploded view of a surface light source device in the liquid crystal display apparatus of the first preferred embodiment;

FIG. 3 is a view of the surface light source device in the liquid crystal display apparatus of the first preferred embodiment;

FIG. 4 is a cross-sectional view of the surface light source device in the liquid crystal display apparatus of the first preferred embodiment;

FIG. 5 is a view of the surface light source device in the liquid crystal display apparatus of the first preferred embodiment;

FIGS. 6A and 6B are views of the surface light source device in the liquid crystal display apparatus of the first preferred embodiment;

FIG. 7 is a graph showing viewing-angle and brightness characteristics of the surface light source device in the liquid crystal display apparatus of the first preferred embodiment;

FIGS. 8 to 10 are views showing the operation of the liquid crystal display apparatus of the first preferred embodiment;

FIG. 11 is a view of a surface light source device in a liquid crystal display apparatus of a second preferred embodiment;

FIG. 12 is a view showing viewing-angle and brightness characteristics of the surface light source device in the liquid crystal display apparatus of the second preferred embodiment; and

FIGS. 13 and 14 are views showing the operation of the liquid crystal display apparatus of the second preferred embodiment.

### DESCRIPTION OF THE PREFERRED EMBODIMENTS

### First Preferred Embodiment

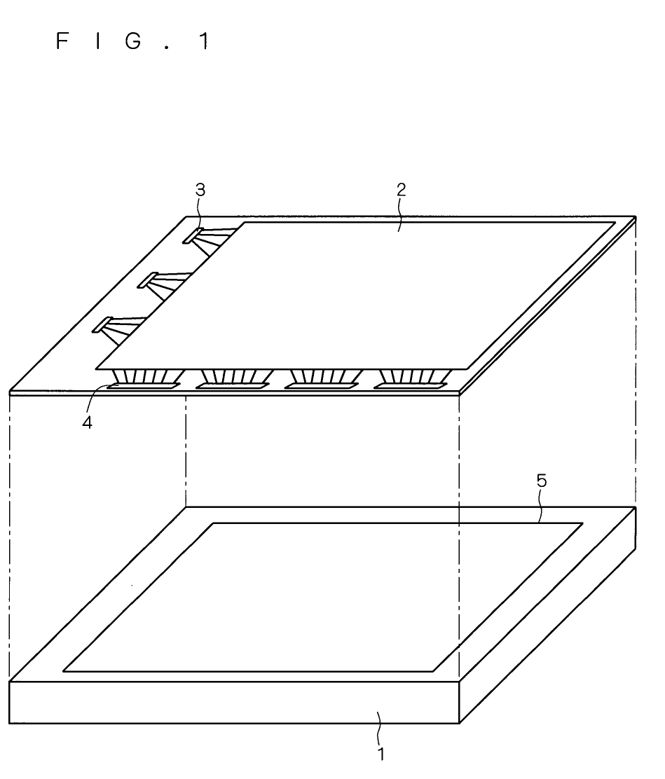

The following description is given on the assumption that display apparatuses according to the invention are liquid crystal display apparatuses. FIG. 1 is an exploded perspective view showing an example of the outline configuration of a liquid crystal display apparatus of the present preferred embodiment. As shown in the figure, the liquid crystal display apparatus of the present preferred embodiment includes a surface light source device 1, a liquid crystal panel 2, gate drivers 3, and source drivers 4.

The surface light source device 1 has a main surface from which light is emitted. In the present preferred embodiment, light from the main surface of this surface light source device 1 illuminates the liquid crystal panel 2 through an opening 5. The surface light source device 1 is placed on the back surface side of the liquid crystal panel 2 and irradiates the back surface side of the liquid crystal panel 2 with light. The liquid crystal panel 2 as a display device is provided along the main surface side of the surface light source device 1 and modulates light from the main surface by data writing. The liquid crystal panel 2 holds liquid crystal between a counter substrate and a TFT (Thin Film Transistor) array substrate.

A display area of the liquid crystal panel 2 formed in a sheet has a large number of pixels arranged in a matrix, and a TFT as a semiconductor switching element is provided for each pixel. The display area has gate lines (address lines) formed in parallel with a direction along the long edge of the display area, and source lines (data lines) formed in parallel with a direction along the short edge of the display area. Around the display area, there are formed a plurality of gate drivers 3 for turning on or off the TFTs through the gate lines, and a plurality of source drivers 4 for supplying image data to each pixel from the source lines through the TFTs. These gate drivers 3 and source drivers 4 are, for example, formed on the TFT array substrate as semiconductor chips. The writing of data to each pixel is conducted by a controller controlling each of the above-mentioned drivers on the basis of image signals, in which the gate lines are turned on and driven at a certain scan interval so that image data is written in sequence from the source lines to pixels.

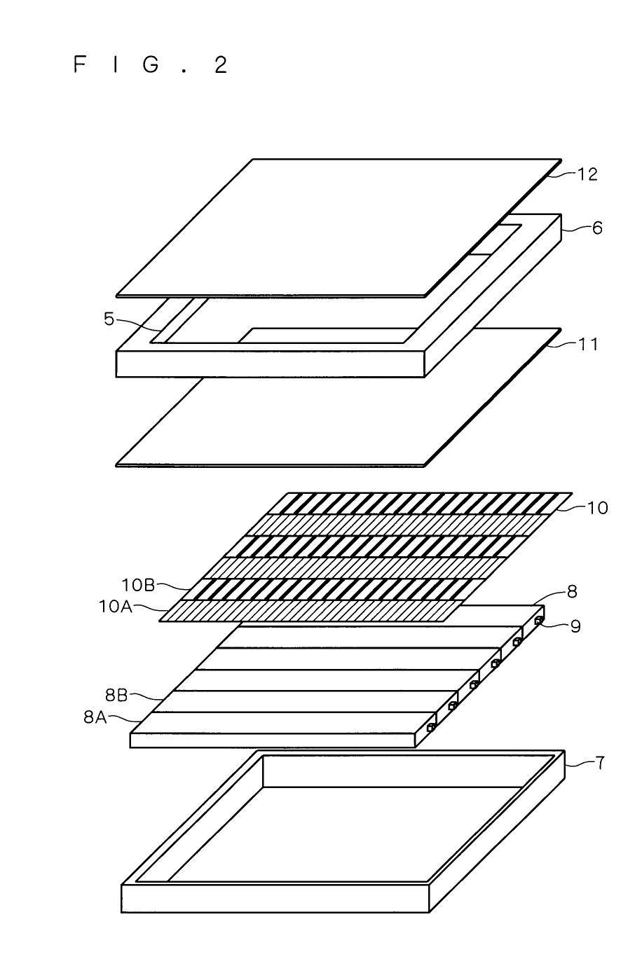

FIG. 2 is an exploded view showing an example of the essential configuration of the surface light source device 1. The surface light source device 1 of the present preferred embodiment includes an upper housing 6, a lower housing 7, light guide plates 8 which are light emitting blocks, LEDs (Light Emitting Diodes) 9, a light-shield slit film 10, a first anisotropic diffusion film 11, a second anisotropic diffusion film 12, a reflecting film, an LED driver, and a substrate supplying power to the LEDs 9. The reflecting film, the LED driver, and the substrate are not shown in the figure.

The upper housing 6 has the opening 5 formed therein, so that through this opening 5, light from the main surface is emitted to the outside. The lower housing 7 is a frame for storing and holding each of the above-mentioned members and is made of synthetic resin excellent in strength and machinability, or of metal. Especially, with a view to dissipating heat generated with light emission of the LEDs 9 which are light sources, it is desirable that the lower housing 7 be made of aluminum or copper excellent in thermal conductivity.

A plurality of light emitting blocks correspond to a plurality of regions obtained by dividing in parallel the main surface from which light is emitted. The light emitting blocks of the present preferred embodiment are the light guide plates 8. The light guide plates 8 are optical members that emit light from their exit surfaces corresponding to the aforementioned regions, when receiving light from the LEDs 9 provided along their end faces. Examples of the material of the light guide plates 8 include, for example, organic resins such as acryl or polycarbonate resins, or members with translucency such as glass. The light guide plates 8 are, for example, flat or wedge-like in shape. In the present preferred embodiment, the light guide plates 8 have long, narrow strips of exit surfaces along the source lines of the liquid crystal panel 2, and each exit surface is provided to have an equal area.

The light guide plates 8 have diffusion patterns formed on the back surface side opposite to the exit surface side. The diffusion patterns are formed with fine features such as irregularities and notches. Light propagating in the light guide plates 8 is diffused by these diffusion patterns and emitted from the exit surfaces of the light guide plates 8.

Examples of the method for forming diffusion patterns include, for example, a method for printing dot patterns using a white pigment containing titanium oxide, and a method of forming fine patterns of a circular, conical, or rectangular shape at the formation of the light guide plates 8. The density, shape, size, and depth of these diffusion patterns determine the brightness distribution of emitted light. In the present preferred embodiment, the diffusion patterns are controlled in such a way that, when the main surface is viewed in a plane, the direction of light emitted from the light guide plates 8 coincides with the direction of division of the light guide plates 8.

FIG. 3 is a plan view showing an example of the essential configuration of the surface light source device 1 shown in FIG. 2. On the back surface side of the light guide plates 8, a reflecting film not shown that reflects light toward the exit surface side is placed in order to prevent light inside the light guide plates 8 from emerging from surfaces other than the exist surfaces. The reflecting film is a film-form optical part that is formed of a silver-deposited flat plate or a white resin plate. For effective emission of light from the LEDs 9, it is preferable that the reflecting film should have a reflectance of 90% or more.

In the present preferred embodiment, side reflecting plates not shown are provided between each adjacent pair of the light guide plates 8. The side reflecting plates reflect light, which is irregularly reflected by fine patterns on the side of the light guide plates 8 opposite to the exit surface side and is then emitted from the side faces of the light guide plates 8, toward the inside of the light guide plates 8 so that the light can propagate again in the light guide plates 8. The side reflecting plates are, for example, optical members such as silver-deposited flat plates. Such side reflecting plates are placed between the side faces of each adjacent pair of the light guide plates 8 with an air space therebetween or without an air space but using adhesives with translucency. As another alternative, the side reflecting plates may be formed by depositing silver between the side faces of each adjacent pair of the light guide plates 8.

As shown in FIG. 3, the LEDs 9 or light sources which are turned on or off under the control of an LED driver 13 as a light driver are provided along the end faces of the light guide plates 8. Alternatively, the light sources may be LDs (Laser Diodes).

As the LEDs 9, the present preferred embodiment employs a plurality of LEDs that emit single-color, white light. The LEDs that emit white light are not limited to this, and they may be pseudo white LEDs that emit white light by themselves or may be a combination of R (red), G (green), and B (blue) LEDs. In the latter case, the color tone can be readily changed by controlling the amount of light emission of each color of the LEDs 9. Besides, color reproductivity in image display on the liquid crystal panel 2 can be improved. The LEDs 9 are, for example, mounted on a printed circuit board to protrude therefrom.

As shown in FIG. 3, the light guide plates 8 are divided into two groups: light guide plates 8A and light guide plates 8B. The LEDs 9 provided along the light guide plates 8 are electrically connected in series alternately and connected to the LED driver 13. The LED driver 13 as the light driver controls the turning on and off of the plurality of light guide plates 8. The LEDs 9 are turned on and off under the control of the LED driver 13.

The LED driver 13 of the present preferred embodiment, as shown in FIG. 3, divides the LEDs 9 into two groups, LEDs 9A and LEDs 9B, and controls the turning on and off of each group independently. In other words, it is possible to turn on only either the LEDs 9A or LEDs 9B or to turn on both the LEDs 9A and the LEDs 9B. In this way, the LED driver 13 controls the turning on and off of each group of the light guide plates 8A and 8B.

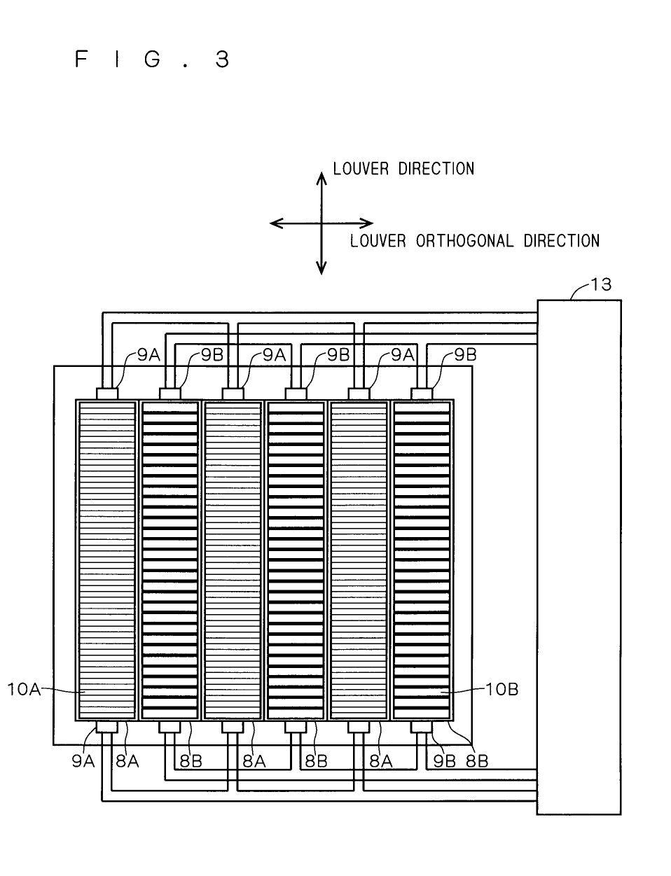

FIG. 4 shows a cross-sectional view of the essential configuration of the surface light source device 1 shown in FIG. 2. As shown in FIG. 4, an optical film is provided on the exit surface side of the light guide plates 8. This optical film includes the light-shield slit film 10 which transmits light that is emitted from the light guide plates 8 and that is within a certain range of angles. Between the light-shield slit film 10 and the light guide plates 8, there is provided an optical film 14 excluding the light-shield slit film 10.

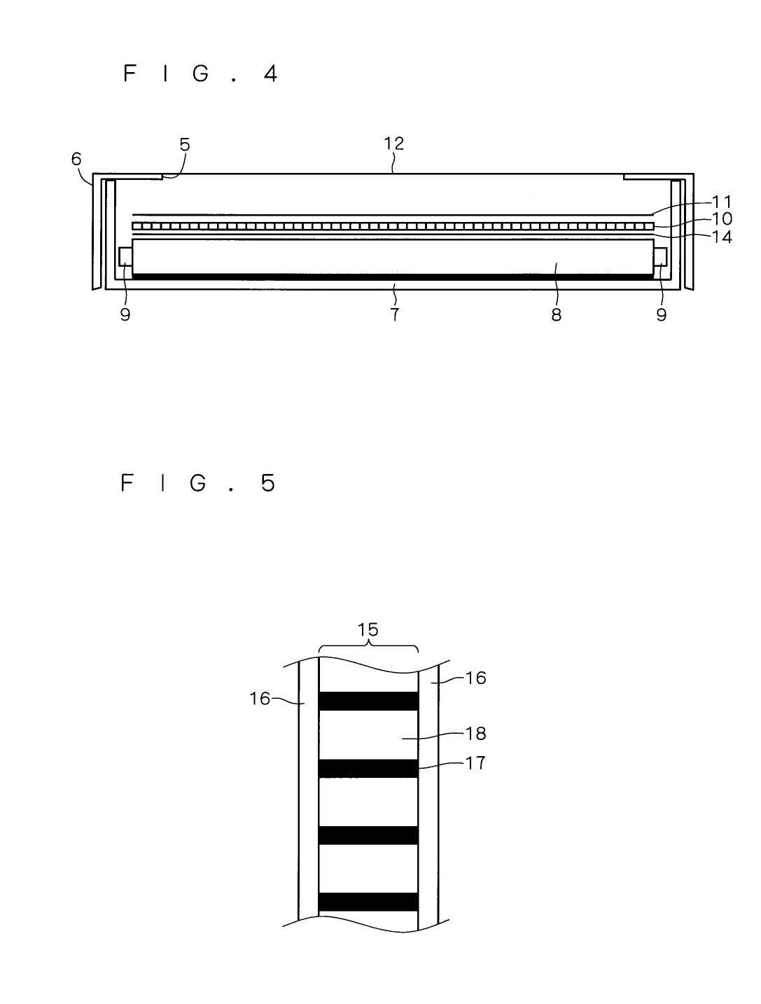

FIG. 5 shows a cross-sectional view of the light-shield slit film 10 when cut in the direction of thickness. The light-shield slit film 10 is divided into a viewing-angle control layer 15 and a protective film layer 16 with respect to the direction of thickness. The viewing-angle control layer 15 has light block parts 17 and light transmission parts 18 alternately layered in a direction generally perpendicular to the film face. In the present example, the protective film layer 16 and the light transmission parts 18 are optical members that transmit light, and the light block parts 17 are an optical member that reflects and absorbs light.

Light incident on this viewing-angle control layer 15 at angles out of tolerance is absorbed or reflected by the light block parts 17. Thus, the light-shield slit film 10 transmits only incident light within a certain range of angles. When the thickness of the viewing-angle control layer 15 is constant, reducing the pitch of the light block parts 17 narrows a certain range of angles, while increasing the pitch of the light block parts 17 widens a certain range of angles. When the pitch of the light block parts 17 is constant, increasing the thickness of the viewing-angle control layer 15 narrows a certain range of angles, while reducing the thickness of the viewing-angle control layer 15 widens a certain range of angles. Referring to FIG. 5, the direction in which the light block parts 17 are laid is angled relative to the direction of thickness of the light-shield slit film 10, the direction in which the maximum amount of light is transmitted is a direction that is tilted at the angle concerned, with respect to the direction of the thickness of the light-shield slit film 10.

In the present preferred embodiment, a certain range of angles of light passing through the light-shield slit film 10 differs between the groups of the light guide plates 8 (between the light guide plates 8A and 8B). Hereinafter, the parts of the light-shield slit film 10 that correspond to the light guide plates 8A are referred to as light-shield slit films 10A, and the parts of the light-shield slit film 10 that correspond to the light guide plates 8B as light-shield slit films 10B. As shown in FIG. 3, the light-shield slit film 10 includes a plurality of light-shield slit films 10A and 10B having different certain ranges of angles and arranged alternately.

When the light-shield slit film 10 is viewed from front as shown in FIG. 3, the direction (lateral direction in FIG. 3) in which the light block parts 17 are laid is hereinafter referred to as a louver orthogonal direction, and the direction (longitudinal direction in FIG. 3) orthogonal to the direction in which the light block parts 17 are laid is hereinafter referred to as a louver direction. The light block parts 17 which are slits of the light-shield slit film 10 are laid orthogonal to the direction in which the light guide plates 8 are divided.

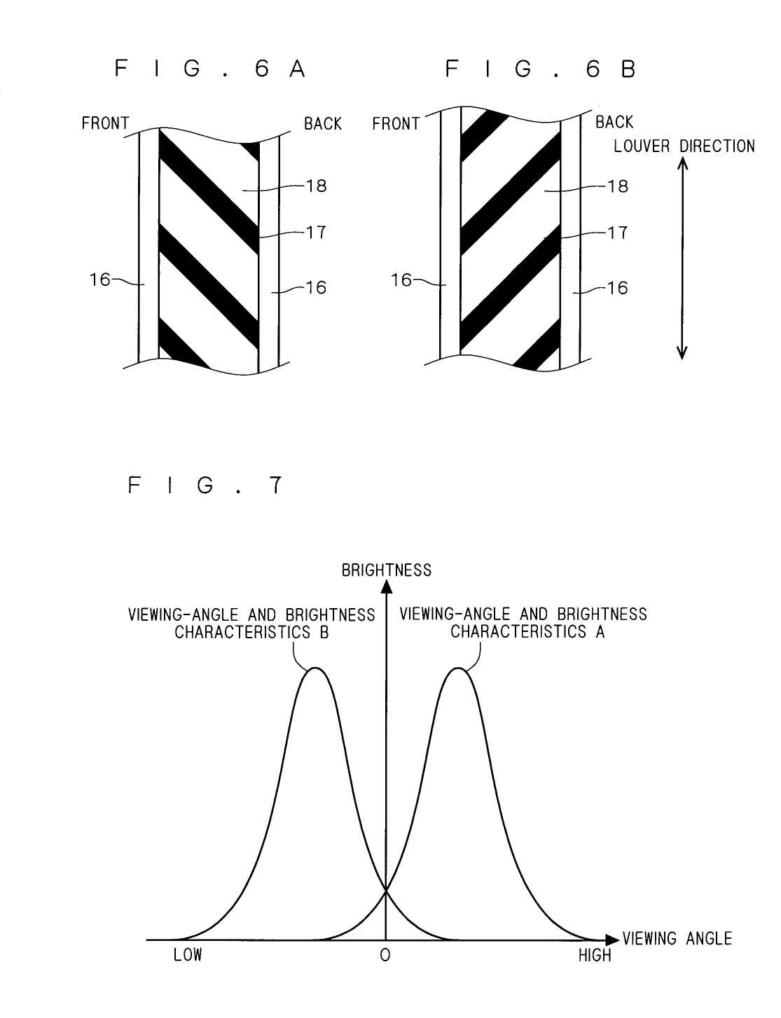

FIG. 6A shows a cross-sectional view of the light-shield slit films 10A when viewed in the louver orthogonal direction, and FIG. 6B shows a cross-sectional view of the light-shield slit films 10B when viewed in the louver orthogonal direction. In both of FIGS. 6A and 6B, the left hand side corresponds to the front side of FIG. 3, and the right hand side corresponds to the back side of FIG. 3. In the present preferred embodiment, the light block parts 17 of the light-shield slit films 10A, as shown in FIG. 6A, are angled upwards from the back toward the front side. The light block parts 17 of the light-shield slit films 10B, as shown in FIG. 6B, are angled downwards from the back toward the front side. In this way, the slits of the light-shield slit film 10 are tilted to the direction of division of the light guide plates 8 (i.e., the louver direction of FIG. 3).

Referring to FIG. 3, either when the LEDs 9A are tuned on or when the LEDs 9B are turned on, the direction of light passing through the light-shield slit films 10A and 10B with respect to the louver orthogonal direction has little change before and after transmission. In other words, the light-shield slit films 10A and 10B do not impose limitations on the viewing angle in the louver orthogonal direction. However, the direction of transmitted light with respect to the louver direction differs between when the LEDs 9A are turned on and when the LEDs 9B are turned on.

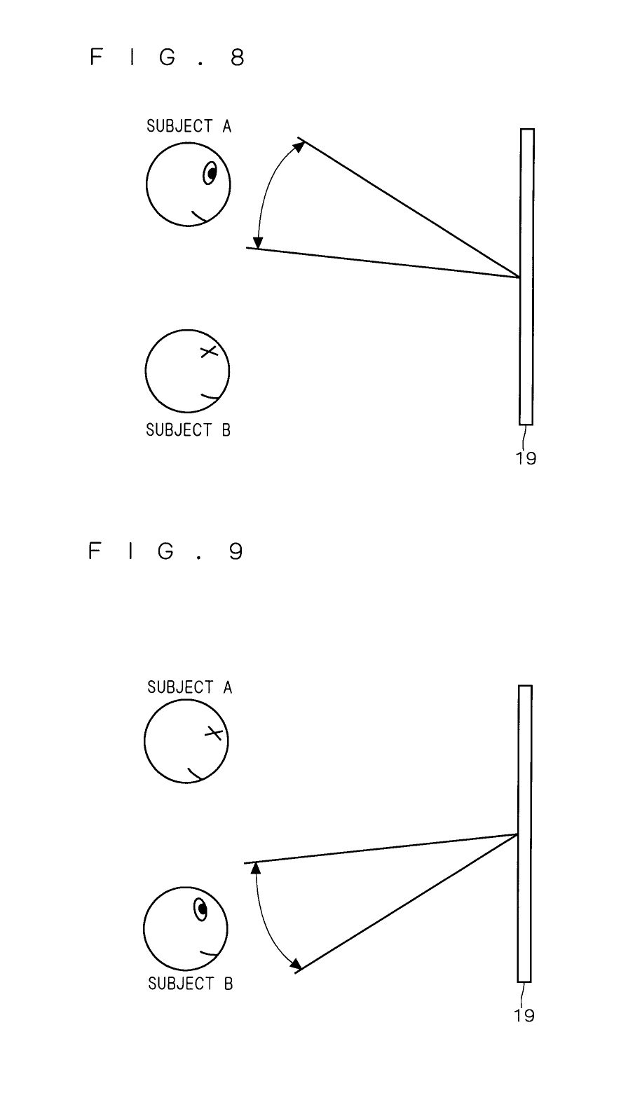

FIG. 7 shows viewing-angle and brightness characteristics of the light-shield slit film 10 shown in FIG. 3. As incident light, complete diffuse light that includes light traveling in various directions shall be adopted. The vertical axis of the drawing indicates the brightness. The horizontal axis of the drawing indicates the viewing angle relative to the light-shield slit film 10, where 0 degrees or more are the viewing angles at which the vertically-placed light-shield slit film 10 is looked down from above, and 0 degrees or less are the viewing angles at which the light-shield slit film 10 is looked up from below. In this figure, the viewing-angle and brightness characteristics of the light-shield slit films 10A are referred to as viewing-angle and brightness characteristics A, and the viewing-angle and brightness characteristics of the light-shield slit films 10B as viewing-angle and brightness characteristics B.

As is seen from FIG. 7, when the LEDs 9A are turned on, the intensity of light is high only within a certain range of angles of the light-shield slit films 10A, i.e., only within part of the range of viewing angles at which the light-shield slit films 10A are looked down from above. On the other hand, when the LEDs 9B are turned on, the intensity of light is high only within a certain range of angles of the light-shield slit films 10B, i.e., only within part of the range of viewing angles at which the light-shield slit films 10B are looked up from below. In this way, the light-shield slit films 10A and 10B limit the range of viewing angles in the louver direction.

Next, referring back to FIG. 4, the other part of the configuration of the surface light source device 1 is described. The surface light source device 1 of the present preferred embodiment includes at least one anisotropic diffusion film that is provided on the exit surface side of the aforementioned light-shield slit film 10 and that causes directional diffusion of light emitted from the light-shield slit film 10 within a certain range of angles of the light-shield slit film 10.

In the present preferred embodiment, the anisotropic diffusion film causes directional diffusion of light emitted from the light-shield slit film 10, in parallel with the direction of division of the light guide plates 8. In FIG. 4, the first and second anisotropic diffusion films 11 and 12 are equivalent to this anisotropic diffusion film. The first anisotropic diffusion film 11 is provided along the light-shield slit film 10, and the second anisotropic diffusion film 12 is provided along the opening 5. In the present example, the first anisotropic diffusion film 11 and the second anisotropic diffusion film 12 have a space therebetween so that they are apart from each other. Such first and second anisotropic diffusion films 11 and 12, for example, have a co-continuous structure, or an intermediate structure between co-continuous and droplet structures, formed inside the film by phase separation of a plurality of polymers by means of spinodal decomposition.

Those first and second anisotropic diffusion films 11 and 12 are arranged to cause generally the same direction of directional diffusion so as to cause a wide diffusion in the louver orthogonal direction shown in FIG. 3, and on the other hand, so as to cause little diffusion in the louver direction. Such arrangement is in order to maintain the range of viewing angles in the louver direction, which range is limited by the light-shield slit film 10.

Arranged as shown in FIG. 4, the first anisotropic diffusion film 11 causes directional diffusion of light emitted from the light-shield slit film 10 within the aforementioned certain range of angles, with respect to the louver orthogonal direction. Similarly, the second anisotropic diffusion film 12 causes directional diffusion of light emitted from the first anisotropic diffusion film 11 within the aforementioned certain range of angles, with respect to the louver orthogonal direction.

Between the light-shield slit film 10 and the light guide plates 8, the optical film 14 excluding the light-shield slit film 10 is provided. This optical film 14 is a film-form optical member with translucency, and is equivalent to, for example, a diffusion film that diffuses light or a prism film formed with an array of prisms. The diffusion film is formed, for example by mixing fine reflectors with a synthetic resin or a transparent member such as glass, or by making a rough surface. For a desired brightness and chromaticity distributions of emitted light, a plurality of kinds of such optical films 14 are combined or a plurality of such optical films 14 are employed as necessary. In the present example, the optical film 14 of the same size and shape as the light guide plates 8 is provided for each of the light guide plates 8.

The operation of a liquid crystal display apparatus including the surface light source device 1 with this configuration is described. The description is given on the case where control is exercised such as to supply power to the LEDs 9A but not to supply power to the LEDs 9B, using the LED driver 13 in the surface light source device 1. In this case, light is emitted from the LEDs 9A and enters the end faces of the light guide plates 8A. The light incident on the light guide plates 8A repeatedly reflects on the exit surface side and back surface side of the light guide plates 8A and propagates in the light guide plates 8A. Of the propagating light, light which are randomly reflected by dot patterns formed on the back surface side of the light guide plates 8A is emitted toward the exit surface side. Also, light reflected on the reflecting film of the light guide plates 8A is emitted toward the exit surface side. Then, the emitted light is diffused, gathered, or polarized by the optical film 14 and enters the light-shield slit films 10A.

FIG. 8 shows by the arrow a certain range of angles of light emitted from the light-shield slit films 10A when the LEDs 9A, out of the LEDs 9, are turned on. This range is equivalent to the aforementioned viewing-angle and brightness characteristics A shown in FIG. 7, and as shown in FIG. 8, the light-shield slit films 10A transmit only light within part of the range of viewing angles at which a liquid crystal display apparatus 19 is looked down from above.

Since the LEDs 9A which are alternately arranged are turned on, when the light passing through the light-shield slit film 10 is viewed, vertical stripes of bright parts are visually recognized at the sites of the light guide plates 8A, and vertical stripes of dark parts are visually recognized at the sites of the light guide plates 8B. The result is visual recognition of the vertical stripes of bright and dark parts which are alternately arranged. Making those vertical stripes of dark parts invisible is the role of the first and second anisotropic diffusion films 11 and 12.

The first anisotropic diffusion film 11 causes directional diffusion of incident light in the louver orthogonal direction and emits the light toward the opening 5 of the upper housing 6. During the period when the emitted light passes through the space between the first anisotropic diffusion film 11 and the second anisotropic diffusion film 12, the amount of that light in the louver orthogonal direction becomes uniform. Then, in the vicinity of the opening 5 where the liquid crystal panel 2 is provided, the second anisotropic diffusion film 12 causes further directional diffusion of the light which was subjected to directional diffusion by the first anisotropic diffusion film 11, in the louver orthogonal direction.

These first and second anisotropic diffusion films 11 and 12 do not diffuse light in the louver direction, so that the range of viewing angles limited by the light-shield slit films 10A can be maintained. In this way, the first and second anisotropic diffusion films 11 and 12 make vertical stripes of dark parts invisible while maintaining the range of viewing angles controlled by the light-shield slit film 10. While, in the above description, the light guide plates 8A correspond to bright parts and the light guide plates 8B to dark parts, even if the light guide plates 8A correspond to dark parts and the light guide plates 8B to bright parts, vertical stripes of dark parts can be made invisible in a similar way.

Light emitted from the main surface of the surface light source device 1 enters the liquid crystal panel 2 and is transmitted through and emitted from a polarizing layer, a liquid crystal layer, a color filter layer, and a polarizing layer in this order. Here, the direction of light emitted from the liquid crystal panel 2 is generally identical to the direction of emission from the surface light source device 1 shown in FIG. 8. Accordingly, when, as in the case of subject A in FIG. 8, the liquid crystal display apparatus 19 is viewed within the range of viewing angles of the light-shield slit films 10A, the display screen is bright so that the display on the liquid crystal display apparatus 19 is visually recognizable. On the other hand, when, as in the case of subject B in FIG. 8, the liquid crystal display apparatus 19 is viewed out of the range of viewing angles of the light-shield slit films 10A, the display screen is dark so that the display on the liquid crystal display apparatus 19 is visually unrecognizable.

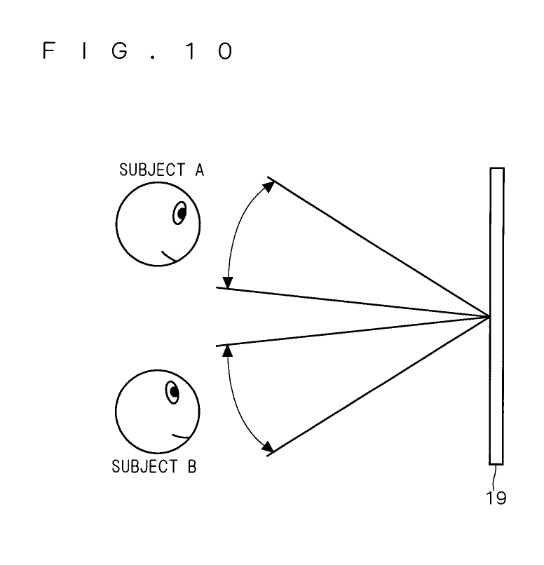

FIG. 9 shows by the arrow a certain range of angles of light emitted from the light-shield slit films 10B when the LEDs 9B, out of the LEDs 9, are turned on. This range corresponds to the aforementioned viewing-angle and brightness characteristics B shown in FIG. 7, and as shown in FIG. 9, the light-shield slit films 10B transmit only light within part of the range of viewing angles at which the liquid crystal display apparatus 19 is looked up from below.

Here, the direction of light emitted from the liquid crystal panel 2 is generally identical to the direction of emission from the surface light source device 1 shown in FIG. 9. Accordingly, when, as in the case of subject B in FIG. 9, the liquid crystal display apparatus 19 is viewed within the range of viewing angles of the light-shield slit films 10B, the display screen is bright so that the display on the liquid crystal display apparatus 19 is visually recognizable. On the other hand, when, as in the case of subject A in FIG. 9, the liquid crystal display apparatus 19 is viewed out of the range of viewing angles of the light-shield slit films 10B, the display screen is dark so that the display on the liquid crystal display apparatus 19 is visually unrecognizable.

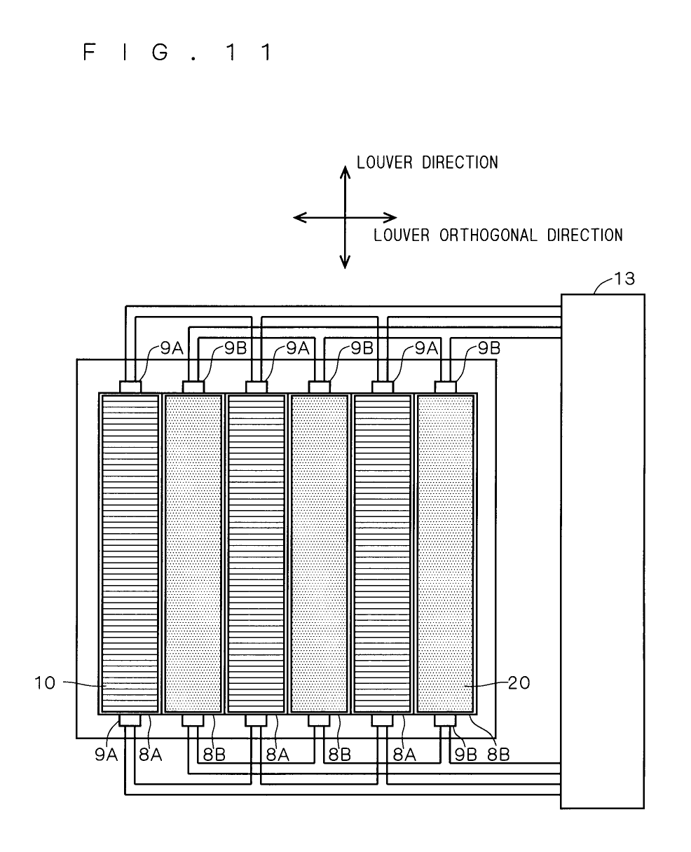

FIG. 10 shows by the arrow certain ranges of angles of light emitted from the light-shield slit films 10A and 10B when the LEDs 9A and the LEDs 9B are both turned on at the same time. As shown in FIG. 10, the light-shield slit films 10A transmit only light within part of the range of viewing angles at which the liquid crystal display apparatus 19 is looked down from above, and the light-shield slit films 10B transmit only light within part of the range of viewing angles at which the liquid crystal display apparatus 19 is looked up from below.

Here, the direction of light emitted from the liquid crystal panel 2 is generally identical to the direction of emission from the surface light source device 1 shown in FIG. 10. Accordingly, when, as in the case of subject A in FIG. 10, the liquid crystal display apparatus 19 is viewed within the range of viewing angles of the light-shield slit films 10A, the display screen is bright so that the display on the liquid crystal display apparatus 19 is visually recognizable. At the same time, when, as in the case of subject B in FIG. 10, the liquid crystal display apparatus 19 is viewed within the range of viewing angles of the light-shield slit films 10B, the display screen is bright so that the display on the liquid crystal display apparatus 19 is visually recognizable. On the other hand, when the liquid crystal display apparatus 19 is viewed out of those ranges of viewing angles, the display screen is dark so that the display on the liquid crystal display apparatus 19 is visually unrecognizable.

As described above, the liquid crystal display of the present preferred embodiment has two options in selection of the range of viewing angles and thus can give protection to privacy data.

Further, the independent turning on and off of each group of the light guide plates 8 allows the maximum of three options in selection of the range of viewing angles. While, in the present preferred embodiment, the light guide plates 8 are divided into two groups, they may be divided into three or more groups to differ correspondingly in a certain range of angles of the light-shield slit film 10. In this case, two or more ranges of viewing angles are provided, which allows finer adjustment of the viewing angles.

The use of the first and second anisotropic diffusion films 11 and 12 makes it possible to make uniform the amount of light in the louver orthogonal direction before the light reaches the opening 5. Consequently, dark parts of the light guide plates 8 that do not emit light can be made invisible.

In the present preferred embodiment, by using the first anisotropic diffusion film 11, the amount of light in the louver orthogonal direction at the opening 5 is made uniform. However, if the thickness of the surface light source device 1 is acceptable and if a sufficient distance is maintained between the second anisotropic diffusion film 12 and the opening 5, the amount of light emitted from the light-shield slit film 10 in the louver orthogonal direction can become uniform before the light reaches the opening 5. In that case, the same effect as described can be achieved without using the first anisotropic diffusion film 11, which results in cost reduction. Further, referring to FIG. 3, the amount of light can be made more uniform by reducing the lateral widths of the light guide plates 8, in which case the distance between the second anisotropic diffusion film 12 and the opening 5 can be reduced. As a result, the thickness of the surface light source device 1 can be reduced.

In the present preferred embodiment, the light guide plates 8 and the light-shield slit film 10 are longitudinally arranged as shown in FIG. 3 so as to control a vertical range of viewing angles as shown in FIGS. 8 to 10. The invention is, however, not limited to this, and the arrangement may be rotated 90 degrees, i.e., the guide plates 8 and the light-shield slit film 10 may be laterally arranged so as to control a lateral range of viewing angles.

### Second Preferred Embodiment

FIG. 11 is a plan view showing an example of the essential configuration of the surface light source device 1 according to another preferred embodiment of the invention. This figure corresponds to FIG. 3 of the first preferred embodiment. Hereinafter, the components similar to those described in the first preferred embodiment are designated by the same reference numerals or characters.

As in the first preferred embodiment, an optical film is provided on the exit surface side of the light guide plates 8. In the present preferred embodiment, the optical film further includes a diffusion film 20 that is alternately arranged with the light-shield slit film 10 and that diffuses light emitted from the light guide plates 8.

As shown in FIG. 11, in the present preferred embodiment, the light-shield slit film 10 is provided along the light guide plates 8A, and the diffusion films 20 is provided along the light guide plates 8B. A certain range of angles of the light-shield slit film 10 shall be in a direction perpendicular to the exit surface of the light guide plate 8. Further, the optical film 14 is provided between the light guide plates 8A and the light-shield slit film 10 and between the light guide plates 8B and the diffusion film 20.

The surface light source device 1 of the present preferred embodiment includes the first and second anisotropic diffusion films 11 and 12 that are provided on the exit surface sides of the aforementioned light-shield slit film 10 and diffusion film 20 and that cause directional diffusion of light emitted from the light-shield slit film 10 and the diffusion film 20 within a certain range of angles of the light-shield slit film 10. The first anisotropic diffusion film 11 is provided along the light-shield slit film 10 and the diffusion film 20, and the second anisotropic diffusion film 12 is provided along the opening 5.

The first and second anisotropic diffusion films 11 and 12, as in the first preferred embodiment, are arranged to cause generally the same direction of directional diffusion so as to cause a wide diffusion of light in the louver orthogonal direction, and on the other hand, so as to cause little diffusion of light in the louver direction.

The operation of a liquid crystal display apparatus including the surface light source device 1 with such configuration is described. The description is given on the case where only the LEDs 9A are turned on and the LEDs 9B are not turned on, using the LED driver 13 in the surface light source device 1. In this case, light is emitted from the LEDs 9A and enters the end faces of the light guide plates 8A. The light incident on the light guide plates 8A repeatedly reflects on the exit surface side and back surface side of the light guide plates 8A and propagates in the light guide plates 8A. Of the propagating light, light which are randomly reflected by dot patterns formed on the back surface side of the light guide plates 8A is emitted toward the exit surface side. Also, light reflected on the reflecting film of the light guide plates 8A is emitted toward the exit surface side. Then, the emitted light is diffused, gathered, or polarized by the optical film 14 and enters the light-shield slit films 10A.

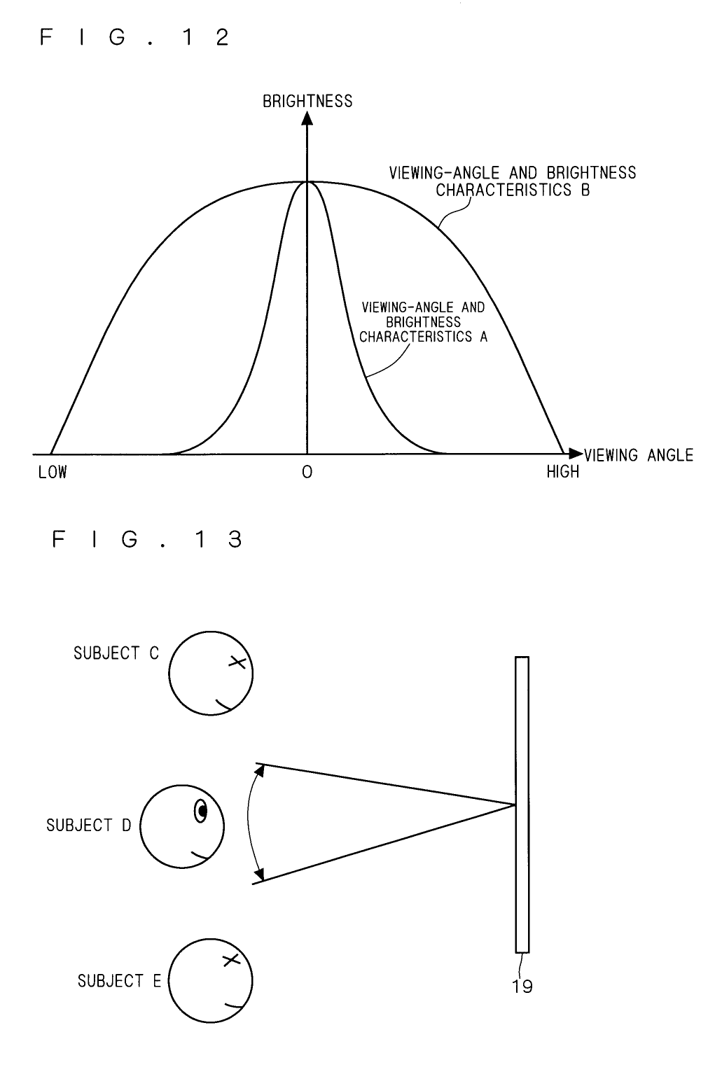

FIG. 12 shows viewing-angle and brightness characteristics of the light-shield slit film 10 and the diffusion film 20. FIG. 12 corresponds to FIG. 3 of the first preferred embodiment. In this figure, the viewing-angle and brightness characteristics of the light-shield slit film 10 are represented as viewing-angle and brightness characteristics A, and the viewing-angle and brightness characteristics of the diffusion film 20 as viewing-angle and brightness characteristics B.

As is seen from FIG. 12, when the LEDs 9A are turned on, the intensity of light is high only within a certain range of angles of the light-shield slit film 10, i.e., only within part of the range of viewing angles at which the liquid crystal display apparatus 19 is viewed from front. On the other hand, when the LEDs 9B are turned on, the intensity of light is high within a wide range of viewing angles because light is diffused by the diffusion film 20. In this way, the light-shield slit film 10 limits the range of viewing angles in the louver direction. On the other hand, the diffusion film 20 widens the range of viewing angles in the louver direction.

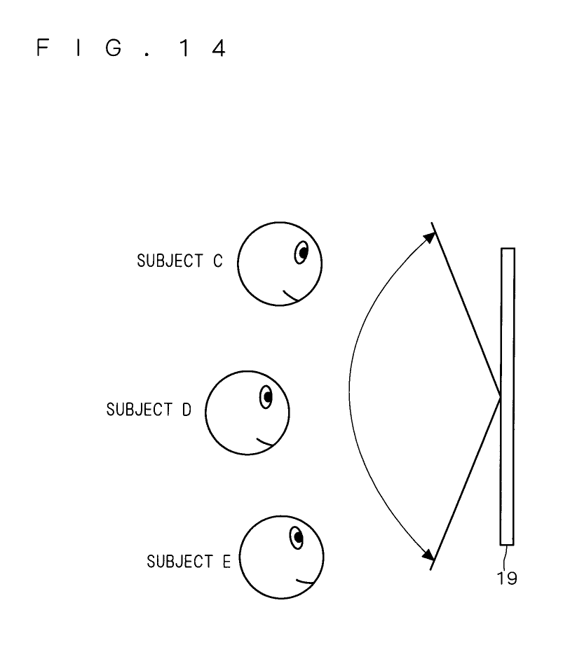

FIG. 13 shows by the arrow a certain range of angles of light emitted from the light-shield slit film 10 when the LEDs 9A, out of the LEDs 9, are turned on. This range is equivalent to the aforementioned viewing-angle and brightness characteristics A shown in FIG. 12, and as shown in FIG. 13, the light-shield slit film 10 transmits only light within part of the range of viewing angles at which the liquid crystal display apparatus 19 is viewed from front.

Here, as in the first preferred embodiment, the first and second anisotropic diffusion films 11 and 12 are arranged so as to cause a wide diffusion of light emitted from the light-shield slit film 10 in the louver orthogonal direction, and on the other hand, so as to cause little diffusion in the louver direction. Accordingly, the first and second anisotropic diffusion films 11 and 12 can make vertical stripes of dark parts invisible while maintaining the range of viewing angles of the light-shield slit film 10.

Light emitted from the main surface of the surface light source device 1 enters the liquid crystal panel 2 and is transmitted through and emitted from a polarizing layer, a liquid crystal layer, a color filter layer, and a polarizing layer in this order. Here, the direction of light emitted from the liquid crystal panel 2 is generally identical to the direction of emission from the surface light source device 1 shown in FIG. 13. Accordingly, when, as in the case of subject D in FIG. 13, the liquid crystal display apparatus 19 is viewed within the range of viewing angles of the light-shield slit film 10, the display screen is bright so that the display on the liquid crystal display apparatus 19 is visually recognizable. On the other hand, when, as in the case of subjects C and E in FIG. 13, the liquid crystal display apparatus 19 is viewed out of the range of viewing angles of the light-shield slit film 10, the display screen is dark so that the display on the liquid crystal display apparatus 19 is visually unrecognizable.

Next, the description is given on the case where only the LEDs 9B are turned on and the LEDs 9A are not turned on, using the LED driver 13 in the surface light source device 1. In this case, light is emitted from the LEDs 9B and enters the end faces of the light guide plates 8B. The light incident on the light guide plates 8B repeatedly reflects on the exit surface side and back surface side of the light guide plates 8B and propagates in the light guide plates 8B. Of the propagating light, light which is randomly reflected by dot patterns formed on the back surface side of the light guide plates 8B is emitted toward the exit surface side. Also, light reflected on the reflecting film of the light guide plates 8B is emitted toward the exit surface side. Then, the emitted light is diffused, gathered, or polarized by the optical film 14 and enters the diffusion film 20.

FIG. 14 shows by the arrow the range of angles of light emitted from the diffusion film 20 when the LEDs 9B, out of the LEDs 9, are turned on. FIG. 14 shows the range that is equivalent to the aforementioned viewing-angle and brightness characteristics B shown in FIG. 12, and as shown in FIG. 14, the diffusion film 20 causes a wide range of diffusion of light.

Here, as in the first preferred embodiment, the first and second anisotropic diffusion films 11 and 12 are arranged so as to cause a wide diffusion of light emitted from the light-shield slit film 10 in the louver orthogonal direction, and on the other hand, so as to cause little diffusion in the louver direction. Accordingly, the first and second anisotropic diffusion films 11 and 12 can make vertical stripes of dark parts invisible while maintaining the range of viewing angles of the light-shield slit film 10.

Light emitted from the main surface of the surface light source device 1 enters the liquid crystal panel 2 and is transmitted through and emitted from a polarizing layer, a liquid crystal layer, a color filter layer, and a polarizing layer in this order. Here, the direction of light emitted from the liquid crystal panel 2 is generally identical to the direction of emission from the surface light source device 1 shown in FIG. 13. Accordingly, as in the case of subjects C, D, and E in FIG. 14, the display screen is bright within a wide range of viewing angles so that the display on the liquid crystal display apparatus 19 within that range is visually recognizable.

As described above, the liquid crystal display apparatus of the present preferred embodiment has two options in selection of the range of viewing angles. What is different from the first preferred embodiment is that the present preferred embodiment allows selection of either a limited range of viewing angles or a wide range of viewing angles.

The invention is not limited to the light-shield slit film 10 which has the viewing-angle and brightness characteristics shown in FIG. 12, and the light-shield slit film 10 which has a different range of viewing angles may be provided along the light guide plates 8A. Further, when the LEDs 9A and the LEDs 9B are both turned on, it is possible to have another third viewing-angle and brightness characteristics added to the aforementioned two viewing-angle and brightness characteristics.

While the invention has been shown and described in detail, the foregoing description is in all aspects illustrative and not restrictive. It is therefore understood that numerous modifications and variations can be devised without departing from the scope of the invention.

What is claimed is:

1. A surface light source device having a main surface from which light is emitted,
said surface light source device comprising:
a plurality of light emitting blocks corresponding to a plurality of regions obtained by dividing said main surface in parallel;
an optical film provided on an exit surface side of said plurality of light emitting blocks; and
a light driver controlling the turning on and off of said plurality of light emitting blocks,
said optical film including a light-shield slit film which transmits light that is emitted from said plurality of light emitting blocks and that is within a certain range of angles.

2. The surface light source device according to claim 1, wherein
said optical film further includes a diffusion film that is arranged alternately with said light-shield slit film and that diffuses light emitted from said plurality of light emitting blocks.

3. The surface light source device according to claim 1, wherein
said light-shield slit film includes a plurality of light-shield slit films having different said certain ranges of angles and arranged alternately.

4. The surface light source device according to claim 1, wherein
said plurality of light emitting blocks are divided into groups,
said certain range of angles of light passing through said light-shield slit film differs for each of said groups, and
said light driver controls the turning on and off of said plurality of light emitting blocks for each of said groups.

5. The surface light source device according to claim 1, wherein
each of said plurality of light emitting blocks includes a light guide plate,
said surface light source device further comprising:
a light source that is provided along an end face of said light guide plate and that is turned on and off under the control of said light driver.

6. The surface light source device according to claim 5, wherein
said light source includes a light emitting diode.

7. The surface light source device according to claim 1, further comprising:
at least one anisotropic diffusion film that is provided on an exist surface side of said optical film and that causes directional diffusion of light emitted from said optical film within said certain range of angles.

8. The surface light source device according to claim 7, wherein
said anisotropic diffusion film causes directional diffusion of light emitted from said optical film, in parallel with a direction of the division of said plurality of light emitting blocks.

9. The surface light source device according to claim 1, wherein
said light-shield slit film has slits formed perpendicular to a direction of the division of said plurality of light emitting blocks.

10. A display apparatus comprising:
a surface light source device having a main surface from which light is emitted,
said surface light source device comprising:
a plurality of light emitting blocks corresponding to a plurality of regions obtained by dividing said main surface in parallel;
an optical film provided on an exit surface side of said plurality of light emitting blocks; and
a light driver controlling the turning on and off of said plurality of light emitting blocks,
said optical film including a light-shield slit film which transmits light that is emitted from said plurality of light emitting blocks and that is within a certain range of angles,
said display apparatus further comprising:
a display device provided along said main surface of said surface light source device and modulating light emitted from said main surface.
